(19) United States
(12) Patent Application Publication
(10) Pub. No.: US 2020/0089522 A1
(43) Pub. Date: Mar. 19, 2020

(54) CONFIGURATION OF SPEED OF VIRTUAL NETWORK INTERFACE CARD

(71) Applicant: BEIJING SANKUAI ONLINE TECHNOLOGY CO., LTD., Beijing (CN)

(72) Inventor: Jian QIU, Beijing (CN)

(21) Appl. No.: 16/685,515

(22) Filed: Nov. 15, 2019

Related U.S. Application Data
(63) Continuation of application No. PCT/CN2017/117514, filed on Dec. 20, 2017.

(30) Foreign Application Priority Data
Jun. 23, 2017 (CN) 201710487161.1

(51) Int. Cl. G06F 9/455; H04L 12/24

(52) U.S. Cl. CPC G06F 9/45558; H04L 41/0803; G06F 2009/45579; G06F 2009/45595; G06F 2009/4557; H04L 41/0896

(57) ABSTRACT

The present disclosure provides a method and an apparatus for configuring a speed of a virtual network interface card (NIC). The method includes: after a virtual machine (VM) is started, configuring an initial transmission speed of a virtual NIC in the VM by using an internal interface set in the VM, and saving the initial transmission speed in the virtual NIC, where the internal interface is used to configure a transmission speed of the virtual NIC and allow communication with an external interface of a physical machine; and during the running of the VM, if the transmission speed of the virtual NIC needs to be modified, invoking the external interface to obtain a target transmission speed, and reconfiguring the target transmission speed as the transmission speed of the virtual NIC via the internal interface.

### CROSS-REFERENCE TO RELATED APPLICATIONS

This application claims priority to Chinese Patent Application No. 201710487161.1, filed on Jun. 23, 2017 and entitled “METHOD AND APPARATUS FOR CONFIGURING SPEED OF VIRTUAL MACHINE NETWORK INTERFACE CARD”, which is incorporated herein by reference in its entirety.

### BACKGROUND

### Technical Field

The present disclosure relates to the field of network transmission technology, and in particular, to a method for configuring a speed of a virtual network interface card (NIC) and an apparatus for configuring a speed of a virtual NIC.

### Related Art

With the ongoing development of computer technology, an increasing number of users use software to simulate a full computer system that has full hardware system functions and runs in a completely isolated environment. In this way, a user may virtualize one physical server into a plurality of virtual machines (VMs), to improve the utilization of server resources and reduce use costs.

An administrator of a server or application software may use specific tool software to obtain a maximum transmission speed (a speed limit of a NIC) of a physical NIC. For example, a transmission speed of an installed NIC is obtained by using a command ethtool for querying and setting a parameter of a NIC or by reading fields such as sys/class/net/ethX/speed in a Linux system.

However, in a VM, an actual maximum transmission speed of a virtual NIC usually cannot be obtained by using the foregoing method. The reason is that in a virtualized environment, a speed indicator of a virtual NIC in a VM is different from a speed indicator of a physical NIC and generally does not have actual reference value. Therefore, a maximum bandwidth cannot be obtained for a VM by using a speed indicator of a virtual NIC.

### SUMMARY

In view of the foregoing problem, embodiments of the present disclosure are proposed to provide a method for configuring a speed of a virtual NIC and an apparatus for configuring a speed of a virtual NIC that overcomes the foregoing problem or at least partially resolve the foregoing problem.

According to an aspect of the present disclosure, a method for configuring a speed of a virtual NIC is provided and includes:

after a VM is started, configuring an initial transmission speed of a virtual NIC in the VM by using an internal interface set in the VM, and saving the initial transmission speed in the virtual NIC, where the internal interface is used to configure a transmission speed of the virtual NIC and allow communication with an external interface of a physical machine; and

during the running of the VM, if the transmission speed of the virtual NIC needs to be modified, invoking the external interface to obtain a target transmission speed, and reconfiguring the target transmission speed as the transmission speed of the virtual NIC via the internal interface.

In an example, the internal interface is generated in the following manner:

obtaining a system file of the virtual NIC;

adding a specified field to the system file; and

using the system file added with the specified field as the internal interface.

In an example, the saving the initial transmission speed in the virtual NIC includes:

reading the initial transmission speed from the specified field of the internal interface; and

saving the initial transmission speed in the virtual NIC.

In an example, the reconfiguring the target transmission speed as the transmission speed of the virtual NIC via the internal interface includes:

replacing the initial transmission speed in the specified field of the internal interface with the target transmission speed; and

saving the target transmission speed in the virtual NIC.

In an example, the VM performs communication based on the target transmission speed of the virtual NIC.

In an example, the target transmission speed includes a real-time speed of an external network or a preset limit speed.

In an example, the internal interface further allows communication with an application program running in the VM, so that the application program obtains the transmission speed of the virtual NIC via the internal interface.

In an example, the determining whether the transmission speed of the virtual NIC needs to be modified includes:

determining whether network bandwidth usage of the application program running in the VM reaches a preset threshold; and

if the network bandwidth usage reaches the preset threshold, determining that the transmission speed of the virtual NIC needs to be modified.

In an example, the determining whether the transmission speed of the virtual NIC needs to be modified includes:

determining whether a user has changed network bandwidth; and

if the user has changed the network bandwidth, determining that the transmission speed of the virtual NIC needs to be modified.

The embodiments of the present disclosure include the following advantages:

1. In the embodiments of the present disclosure, a VM provides an interface for setting a speed of a virtual NIC. The interface may be used to read a speed of a virtual NIC or may be used to set a speed of a virtual NIC.

2. In the embodiments of the present disclosure, a virtual NIC driver of an operating system in a VM may be used by a physical machine to obtain a speed of a virtual NIC from an intermediate software layer Hypervisor between a physical machine system and a VM system, and, an interface that can be used by an application program to obtain a speed of a virtual NIC.

3. In the embodiments of the present disclosure, when an interface for setting a speed of a virtual NIC is used to make a modification to a target transmission speed of a virtual NIC, a virtual NIC driver of an operating system in a VM can synchronize the modification.

4. In the embodiments of the present disclosure, an interface for setting a speed of a virtual NIC provided by a VM is compatible with an existing interface for obtaining a speed of a NIC, and a target transmission speed of a virtual NIC can be read without modifying application software.

5. By means of the embodiments of the present disclosure, a VM may obtain an actual speed of a physical machine by using an interface for setting a speed of a virtual NIC provided by the VM, so that bandwidth that can be used by an application program in the VM can be dynamically adjusted, to make better use of network bandwidth resources to fully use network bandwidth resources.

### BRIEF DESCRIPTION OF THE DRAWINGS

FIG. 1 is a flowchart of the steps in an embodiment of a method for configuring a speed of a virtual NIC according to an embodiment of the present disclosure;

FIG. 2 is a flowchart of the steps in an embodiment of a method for obtaining a speed of a virtual NIC according to an embodiment of the present disclosure;

FIG. 3 is a flowchart of the steps in an embodiment of a method for determining a speed of a virtual NIC according to an embodiment of the present disclosure;

FIG. 4 is a flowchart of the steps in an embodiment of a method for setting a speed of a virtual NIC according to an embodiment of the present disclosure; and

FIG. 5 is a structural block diagram of an embodiment of an apparatus for configuring a speed of a virtual NIC according to an embodiment of the present disclosure.

### DETAILED DESCRIPTION

The following clearly and completely describes the technical solutions in the embodiments of the present disclosure with reference to the accompanying drawings in the embodiments of the present disclosure. The described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

To make the foregoing objectives, features, and advantages of the present disclosure more comprehensible, the present disclosure is further described below in detail with reference to the accompanying drawings and specific implementations.

According to the embodiments of the present disclosure, VM software may be modified, and a command line parameter for setting an initial transmission speed of a virtual NIC may be added. In this way, after a VM is started, each virtual NIC has a speed limit value of an initial transmission speed, and a virtual NIC driver of an operating system running in the VM is modified to allow the operating system in the VM to provide the initial transmission speed to an application program via an internal interface. The VM software may be modified to allow the VM to dynamically modify the speed limit value of the virtual NIC via an external interface in a running state, and the operating system in the VM can provide the modified speed limit value in real time to the application program via the internal interface.

### Embodiment 1

FIG. 1 is a flowchart of the steps in an embodiment of a method for configuring a speed of a virtual NIC according to the present disclosure. The method may specifically include the following steps.

Step 101: After a VM is started, configure an initial transmission speed of a virtual NIC by using an internal interface of the VM, and save the initial transmission speed in the virtual NIC.

In a specific implementation, this embodiment of the present disclosure may be applied to virtual environments of computers. Each virtual environment is equivalent to an independent operating system. A user may, for example, install an application program and store data in a virtual environment.

In this embodiment of the present disclosure, the internal interface of the VM is generated in the following manner: obtaining a system file of the virtual NIC; adding a specified field to the system file; and using the system file added with the specified field as the internal interface of the VM.

During actual application, in this embodiment of the present disclosure, an internal interface for setting a speed of a virtual NIC may be added to a VM. The internal interface may be used to configure an initial transmission speed for a virtual NIC when the VM is started.

For example, in a Linux operating system, a system file is a virtual file sysfs formed by a plurality of fields/sys/class/net/ethX/. After the virtual file sysfs is obtained, a specified field speed is added to turn the virtual file sysfs into a virtual file sysfs formed by the fields sys/class/net/ethX/speed. The modified virtual file sysfs is the internal interface. A speed value of a corresponding NIC is obtained by reading the content of this file.

In this embodiment of the present disclosure, the initial transmission speed in the virtual NIC may be saved in the following manner: reading the initial transmission speed from the specified field of the internal interface, and saving the initial transmission speed in the virtual NIC.

In a specific implementation, in this embodiment of the present disclosure, the initial transmission speed may be read after a command line parameter is used to generate a virtual hardware configuration of the VM.

To enable a person skilled in the art to understand the present disclosure better, this embodiment of the present disclosure provides below a specific reference example:

For example, in a simulated processor qemu, after a specified field speed is added to a command line parameter of the processor qemu, a command line configuration of one virtual NIC is: -netdev virtio-net, mac=00:22:4a:df:cc:d2, id=veth0, and speed=1000, indicating that one virtual NIC is set in the VM, the model is virtio-net, the mac address is 00:22:4a:df:cc:d2, and the maximum transmission speed is 1000 mbps. speed is a command line field added to enter the initial transmission speed of the virtual NIC. A value in the field is saved in the virtual NIC in the VM after the VM starts running.

Certainly, the foregoing example is only a reference example. A person skilled in the art may use other manners to separately generate the internal interface. This is not limited in the present disclosure.

Step 102: During the running of the VM, if a transmission speed of the virtual NIC needs to be modified, invoke an external interface to obtain a target transmission speed, and reconfigure the target transmission speed as the transmission speed of the virtual NIC via the internal interface.

During actual application, in this embodiment of the present disclosure, one external interface for obtaining the target transmission speed may be preset. A user or an external program in a physical machine may transmit the value of the target transmission speed to the VM via the external interface.

In an embodiment of the present disclosure, to enable the VM to obtain an actual speed of an external network environment and enable a user to limit the speed of the VM, the target transmission speed may include a real-time speed of an external network or a preset limit speed.

For example, an application programming interface (API) set_link_speed for setting a link speed is set as the external interface on a control terminal monitor of qemu. After obtaining the real-time speed of the external network, the external interface may use the obtained real-time speed of the external network as the target transmission speed. Alternatively, the user presets a limit speed to be read by the external interface. When the external interface obtains a limit speed, the limit speed is used as the target transmission speed of the VM.

In this embodiment of the present disclosure, the target transmission speed may be reconfigured as the transmission speed of the virtual NIC via the internal interface in the following manner: replacing the initial transmission speed in the specified field of the internal interface with the target transmission speed, and saving the target transmission speed in the virtual NIC.

In a specific implementation, in this embodiment of the present disclosure, after the target transmission speed is obtained, the value of the target transmission speed may be written into the specified field of the internal interface via the external interface to replace the initial transmission speed in the specified field of the internal interface, and the value of the target transmission speed is stored in the virtual NIC.

For example, during the running of the VM, a command line configuration of one virtual NIC is: -netdev virtio-net, mac=00:22:4a:df:cc:d2, id=veth0, and speed=1000, indicating that the VM the current maximum transmission speed is 1000 mbps. If the target transmission speed obtained by the external interface is 500 mbps, the command set_link_speed for setting a link speed of the VM is invoked to change the value in the field speed of the internal interface to 500. The value in the field is saved in the virtual NIC in the VM as the maximum transmission speed of the virtual NIC.

In another embodiment of the present disclosure, the application program running in the VM may further obtain the initial transmission speed of the virtual NIC, or, the target transmission speed via the internal interface.

During actual application, in this embodiment of the present disclosure, a virtual NIC driver used to allow the external interface to obtain the target transmission speed of the virtual NIC from an intermediate software layer Hypervisor between a physical machine system and a VM system is configured in the virtual NIC by modifying VM software implementation code. When the VM is started, the virtual NIC driver can obtain the initial transmission speed of the internal interface, and allow the application program running in the VM to read the internal interface to obtain the initial transmission speed of the virtual NIC.

After the external interface obtains the target transmission speed, the virtual NIC driver may obtain the value of the target transmission speed, synchronize the value of the target transmission speed into the internal interface, and allow the application program running in the VM to read the internal interface to obtain the target transmission speed of the virtual NIC.

For example, during the running of the VM, a command line configuration of one virtual NIC is: -netdev virtio-net, mac=00:22:4a:df:cc:d2, id=veth0, and speed=1000, indicating that the current maximum transmission speed of the VM is 1000 mbps. In this case, the initial transmission speed of the application program running in the VM is 1000 mbps. If the target transmission speed obtained by the external interface is 500 mbps, the VM sends a configuration change interruption to the virtual NIC driver. After obtaining an interruption notification, the virtual NIC driver synchronizes the target transmission speed obtained by the external interface into the internal interface of the virtual NIC and stores the target transmission speed in the field vi->speed of the virtual NIC. When the application program accesses the internal interface sys/class/net/ethX/speed, the value of updated vi->speed is read.

During actual application, by means of this embodiment of the present disclosure, after a VM is started, an internal interface may be used to configure an initial transmission speed of a virtual NIC. After the configuration of the initial transmission speed is completed, a target transmission speed of the virtual NIC may be obtained via an external interface. After the target transmission speed is obtained, the target transmission speed is reconfigured as a transmission speed of the virtual NIC via the internal interface, so that the size of bandwidth that can be used by the virtual NIC can be dynamically adjusted during the running of the VM. In this way, when using a VM, a user can make fuller use of network bandwidth resources.

### Embodiment 2

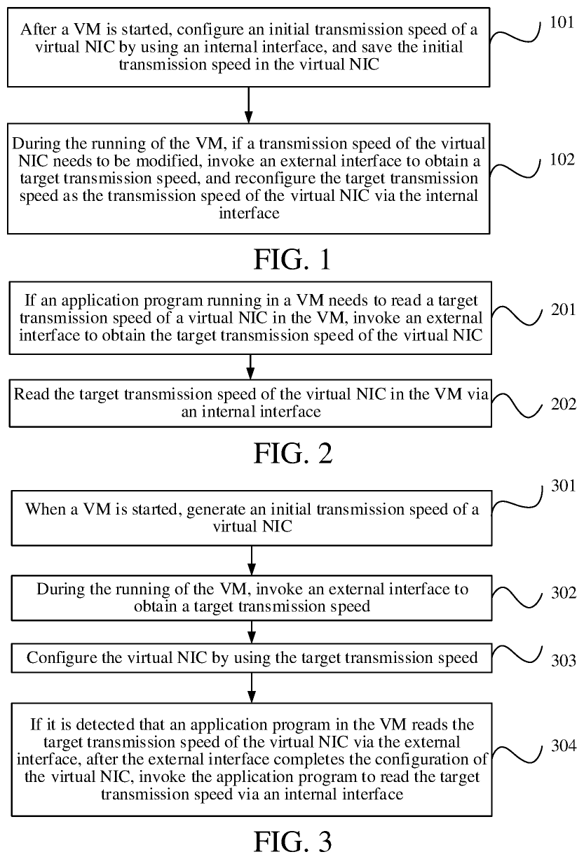

FIG. 2 is a flowchart of the steps in an embodiment of a method for obtaining a speed of a virtual NIC according to the present disclosure. This embodiment is described based on an application program side in a VM. The method may specifically include the following steps.

Step 201: If an application program running in a VM needs to read a target transmission speed of a virtual NIC in the VM, invoke an external interface to obtain the target transmission speed of the virtual NIC.

During actual application, in this embodiment of the present disclosure, the target transmission speed may be obtained via the external interface when the application program running in the VM needs to read the target transmission speed of the virtual NIC in the VM.

In an embodiment of the present disclosure, the following method may be used to determine whether the application program running in the VM needs to read the target transmission speed of the virtual NIC, to determine whether to invoke the external interface of the VM to obtain the target transmission speed of the virtual NIC:

determining whether network bandwidth usage of the application program running in the VM reaches a preset threshold, where if the network bandwidth usage of the application program running in the VM reaches the preset threshold, an interface of the VM may be invoked to obtain the target transmission speed of the virtual NIC.

For example, a user may set an appropriate alarm threshold for network bandwidth usage. When an application program occupies excessive bandwidth, the external interface is invoked to obtain the target transmission speed of the virtual NIC to set a speed limit for the virtual NIC, thereby avoiding excessive use or inefficient use of bandwidth resources of a physical machine.

In another embodiment of the present disclosure, the following method may be used to determine whether the application program running in the VM needs to read the target transmission speed of the virtual NIC in the VM, to determine whether to invoke the interface of the VM to obtain the target transmission speed of the virtual NIC:

determining whether the user reconfigures a bandwidth size, and if the user reconfigures a bandwidth size, invoking the external interface of the VM.

For example, when the user changes a bandwidth speed, the external interface of the VM is invoked to obtain the target transmission speed to reconfigure a transmission speed of the virtual NIC, to enable the virtual NIC to reconfigure the speed limit according to the bandwidth speed of the physical machine, so as to control the transmission speed of the application program running in the VM.

Certainly, a person skilled in the art may use any one or more methods in the foregoing to invoke the interface of the VM. This is not limited in the present disclosure.

Step 202: Read the target transmission speed of the virtual NIC in the VM via an internal interface.

During actual application, by means of this embodiment of the present disclosure, an external interface may be invoked when an application program running in a VM needs to read a target transmission speed of a virtual NIC in the VM, and the target transmission speed of the virtual NIC in the VM is then read via an internal interface, so that the target transmission speed is obtained to control a transmission speed of application software running in the VM.

### Embodiment 3

FIG. 3 is a flowchart of the steps in an embodiment of a method for determining a speed of a virtual NIC according to the present disclosure. This embodiment is described based on a VM side. The method may specifically include the following steps.

Step 301: When a VM is started, generate an initial transmission speed of a virtual NIC.

In an embodiment of the present disclosure, the initial transmission speed of the virtual NIC may be generated in the following manner:

In Manner 1, a command line parameter is added to the virtual NIC to generate an internal interface for setting the initial transmission speed of the virtual NIC, and the internal interface is used to generate the initial transmission speed of the virtual NIC.

In Manner 2, a configuration item is added to the virtual NIC to generate an internal interface for setting the initial transmission speed of the virtual NIC, and the internal interface is used to generate the initial transmission speed of the virtual NIC.

Certainly, a person skilled in the art may use any one or more manner in the foregoing according to an actual requirement to generate the initial transmission speed of the virtual

NIC. This is not limited in the present disclosure.

For example: 1. qemu is modified to allow addition of a field speed to starting parameters of the virtual NIC. The previous starting parameters are -netdev virtio-net, mac=00:22:4a:df:cc:d2, and id=veth0, and are now changed to: -netdev virtio-net, mac=00:22:4a:df:cc:d2, id=veth0, and speed=1000. That is, speed=1000 is added and used to specify that the initial transmission speed of the virtual NIC in the VM is 1000 mbps. 2. qemu is modified, so that after the VM is started, a speed of a NIC is parsed from speed=XXX of a command line parameter and is saved in a local variable. 3. A NIC driver virtio_net of the VM is modified. During initialization, the initial transmission speed of the NIC is read from the VM and is saved in a local variable.

Step 302: During the running of the VM, invoke an external interface to obtain a target transmission speed.

In a specific implementation, in this embodiment of according to the present disclosure, an external interface for obtaining a speed of an external network is configured in the VM. The external interface may configure the obtained speed of the external network as the target transmission speed for the virtual NIC.

For example, monitor implementation code of qemu is modified. An API set_link_speed is added to a management program Hypervisor of the VM and is used by an external control program or administrator during the running of a program of the VM to update a transmission speed of the virtual NIC in real time via a programming interface.

Step 303: Configure the virtual NIC by using the target transmission speed.

In this embodiment of the present disclosure, during the running of the VM, after the external interface obtains the target transmission speed, a virtual NIC driver of the VM may obtain the value of the target transmission speed, overwrite the value of the initial transmission speed with the value of the target transmission speed, and then save the updated value in the virtual NIC.

For example, after the API set_link_speed is invoked, the speed parameter entered via the API is saved in a local variable, and a signal is sent to an operating system in the VM to notify the NIC that there is a change of speed. In addition, a NIC driver in the VM needs to be modified to enable the driver to listen to a speed change event in the NIC. When a speed change event occurs, the NIC driver reads the latest speed from the VM and saves the latest speed locally. An application in the VM reads the latest speed when reading sys/class/net/ethX/speed.

Step 304: If it is detected that an application program in the VM reads the target transmission speed of the virtual NIC via the external interface, after the external interface completes the configuration of the virtual NIC, invoke the application program to read the target transmission speed via an internal interface.

In this embodiment of the present disclosure, the application program running in the

VM may read the value of the target transmission speed in the virtual NIC via the internal interface.

For example, a control command set_link_speed may be added to virtualization software qemu in the VM to allow the virtualization software qemu to dynamically modify the setting of speed of the virtual NIC virtio-net-pci during the running of the VM. A NIC driver virtio-net of the operating system in the VM is then modified, so that the virtual NIC can obtain a notification about the modification of the setting of speed, and can synchronously modify the fields sys/class/net/ethX/speed of sysfs. After the modification, a tool such as ethtool may be used to obtain the modified speed.

To enable a person skilled in the art to understand the present disclosure better, this embodiment of the present disclosure provides below a specific reference example:

S1: qemu is modified to allow addition of a field speed to starting parameters of the virtual NIC. The previous starting parameters are -netdev virtio-net, mac=00:22:4a:df:cc:d2, and id=veth0, and are now changed to: -netdev virtio-net, mac=00:22:4a:df:cc:d2, id=veth0, and speed=1000. That is, speed=1000 is added and used to specify that the initial transmission speed of the virtual NIC in the VM is 1000 mbps.

S2: qemu is modified, so that after the VM is started, and a speed of a NIC is parsed from speed=XXX of a command line parameter and is saved in a local variable.

S3: A NIC driver virtio_net of the VM is modified. During initialization, the initial transmission speed of the NIC is read from the VM and is saved in a local variable.

Certainly, the foregoing example is only a reference example. A person skilled in the art may use other manners to retrieve the target transmission speed from the virtual NIC driver and write the target transmission speed in the external interface. This is not limited in the present disclosure.

During actual application, by means of this embodiment of the present disclosure, when a VM is started, an internal interface may be used to configure an initial transmission speed of a virtual NIC. After the configuration of the initial transmission speed is completed, a target transmission speed of the virtual NIC is obtained via an external interface. The virtual NIC driver then reads the value of the target transmission speed and overwrites the value of the initial transmission speed with the value of the target transmission speed. If it is detected that an application program reads the target transmission speed of the virtual NIC via the external interface, after the external interface completes the configuration of the virtual NIC, the application program is invoked to read the target transmission speed via the internal interface, so that a transmission speed of the virtual NIC for the application program can be dynamically adjusted, to make better use of network bandwidth resources to fully use network bandwidth resources.

### Embodiment 4

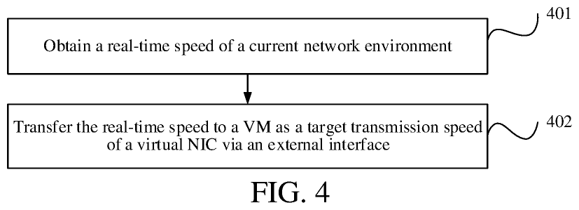

FIG. 4 is a flowchart of the steps in an embodiment of a method for setting a speed of a virtual NIC according to the present disclosure. This embodiment is described based on a physical machine side. The method may specifically include the following steps.

Step 401: Obtain a real-time speed of a current network environment.

Step 402: Transfer the real-time speed to a VM as a target transmission speed of a virtual NIC via an external interface.

In this embodiment of the present disclosure, a virtual NIC driver of an operating system in a VM may be used by a physical machine to obtain a speed of a virtual NIC from an intermediate software layer Hypervisor between a physical machine system and a VM system and may be used by the VM to set the external interface of the virtual NIC.

In this embodiment of the present disclosure, the present disclosure may implement that an operator uses the physical machine to transfer the real-time speed to the VM via the external interface.

During actual application, initial values of the fields sys/class/net/ethX/speed of a system file sysfs in the VM are: the value of the field speed entered via a command line when the VM is created. During the running of the VM, the initial value is used as the target transmission speed of the virtual NIC.

For example, during the running of the VM, a user reduces the target transmission speed of the VM to 500 mbps. A command set_link_speed in the VM is invoked to change the value of speed the virtual NIC in the VM to 500. This change triggers the virtual NIC driver in the VM to update the value of vi->speed. The latest value of speed read from the virtual NIC is 500. When an application program in the VM reads sys/class/net/ethX/speed, the updated speed 500 mbps can be obtained.

To enable a person skilled in the art to better understand the present application, this embodiment of the present disclosure is further described below with reference to an example of specific operations.

S1. Virtualization software qemu is modified, and a field speed is added to the virtual NIC virtio-net to allow entry of the speed of the virtual NIC via a command line.

For example, a command line configuration of one virtual NIC is:

-netdev virtio-net, mac=00:22:4a:df:cc:d2, id=veth0, and speed=1000.

It indicates that one virtual NIC is configured in the VM, the model is virtio-net, the mac address is 00:22:4a:df:cc:d2, and the maximum transmission speed is 1000 mbps. Herein, the speed is a command line field that is added by a user and used to enter an initial transmission speed of the virtual NIC. This value is saved in the virtual NIC in the VM after the VM starts running.

S2. A NIC driver virtio-net of the operating system in the VM is modified to allow the VM qemu to obtain the setting of the field speed, and the fields sys/class/net/ethX/speed of sysfs are updated to allow a tool such as ethtool to obtain the speed.

For example, the driver of the virtual NIC virtio-net in the VM is modified. An interface ethtool_ops. get_settings needs to be implemented in the driver. The interface is invoked to read sys/class/net/ethX/speed in the application program in the VM. Specific steps of implementation the interface include:

A method ethtool_cmd_speed_set is invoked to set the entered value of the field speed of the structure ethtool_cmd. The value is eventually obtained by the application program by accessing the fields sys/class/net/ethX/speed of sysfs. vi->speed indicates that the value of speed is obtained from the virtual NIC in the VM.

S3. The virtualization software qemu is modified. A control command set_link_speed is added to allow dynamic modification of the setting of speed of the virtual NIC virtio-net-pci during the running of the VM qemu. The NIC driver virtio-net of the operating system in the VM is modified, so that a notification about the modification of the setting of speed can be obtained, and the fields sys/class/net/ethX/speed of sysfs can be synchronously modified. After the modification, a tool such as ethtool obtains the modified speed.

For example, set_link_speed is an interface added by a user to the VM. The interface is provided to an external system and is used to modify the setting of speed of the virtual NIC in the VM during the running of the VM.

When the external system invokes an interface set_link_speed of the VM, the value of the field speed of the virtual NIC in the VM is modified. After the modification, the VM sends a configuration change interruption to the virtual NIC driver in the VM. After obtaining an interruption notification, the virtual NIC driver in the VM an I/O port reads the value of the field speed from the virtual NIC and stores the value in the field vi->speed of the virtual NIC. Subsequently, when the application program accesses sys/class/net/ethX/speed, the updated value of the field vi->speed is read.

To enable the virtual NIC virtio-net driver to synchronously update the value of the field vi->speed after obtaining the configuration change interruption, a method virtnet_config_changed of the driver needs to be modified. The method is invoked after the virtual NIC obtains the configuration change interruption. The reading of the value of speed stored in the virtual NIC from the I/O port of the virtual NIC virtio-net needs to be added in the method virtnet_config_changed.

For example, during the creation of the VM, the entered parameter of speed of the virtual NIC is 1000. In this way, after the VM starts running, the value of speed stored in the virtual NIC is 1000. The value read by the application program in the VM from sys/class/net/ethX/speed is also 1000. After the external system invokes a method set_link_speed to change the value of speed stored in the virtual NIC to 500, the virtual NIC driver in the VM synchronously updates the field vi->speed maintained by the virtual NIC driver, reads the latest value from the virtual NIC, and saves the latest value. Subsequently, when the application program in the VM accesses sys/class/net/ethX/speed again, the updated value 500 is read.

It should be noted that the method embodiments are illustrated as a series of action combinations for ease of description; however, a person skilled in the art should know that the embodiments of the present disclosure is not limited to the described order of actions, because based on the embodiments of the present disclosure, some steps may be performed in another order or at the same time. Next, a person skilled in the art should know that the embodiments described in the specification are all preferred embodiments, and the involved actions and modules are not necessarily required in the embodiments of the present disclosure.

During actual application, by means of this embodiment of the present disclosure, after a VM is started, an initial transmission speed of a virtual NIC may be configured via an internal interface. After the configuration of the initial transmission speed is completed, a target transmission speed of the virtual NIC is obtained via an external interface. After the target transmission speed is obtained, the target transmission speed is reconfigured as a transmission speed of the virtual NIC via the internal interface, so that bandwidth that can be used by the virtual NIC can be dynamically adjusted, to make better use of network bandwidth resources to fully use network bandwidth resources.

### Embodiment 5

A machine device and a machine readable storage medium provided in this embodiment of the present disclosure are described in detail.

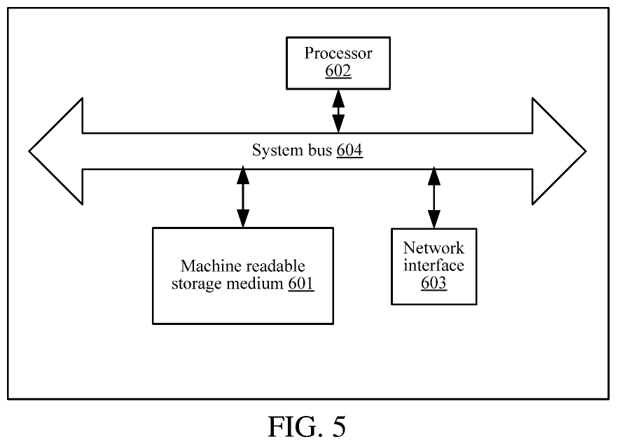

As shown in FIG. 5, this embodiment of the present disclosure provides a machine device, including a storage medium 601, a processor 602, a network interface 603, and a system bus 604. The storage medium 601 is, for example, a non-volatile storage medium. The storage medium 601 stores machine executable instructions that can be run by the processor 602, where the processor 602 executes the machine executable instructions to implement the following steps:

after a VM is started, configuring an initial transmission speed of a virtual NIC in the VM by using an internal interface set in the VM, and saving the initial transmission speed in the virtual NIC, where the internal interface is used to configure a transmission speed of the virtual NIC and allow communication with an external interface of a physical machine; and

during the running of the VM, if the transmission speed of the virtual NIC needs to be modified,

invoking the external interface to obtain a target transmission speed, and

reconfiguring the target transmission speed as the transmission speed of the virtual NIC via the internal interface.

Optionally, the internal interface is generated in the following manner:

obtaining a system file of the virtual NIC;

adding a specified field to the system file; and

using the system file added with the specified field as the internal interface.

Optionally, the saving the initial transmission speed in the virtual NIC includes:

reading the initial transmission speed from the specified field of the internal interface; and

saving the initial transmission speed in the virtual NIC.

Optionally, the reconfiguring the target transmission speed as the transmission speed of the virtual NIC via the internal interface includes:

replacing the initial transmission speed in the specified field of the internal interface with the target transmission speed; and

saving the target transmission speed in the virtual NIC.

Optionally, the VM performs communication based on the target transmission speed of the virtual NIC.

Optionally, the target transmission speed includes a real-time speed of an external network or a preset limit speed.

Optionally, the internal interface further allows communication with an application program running in the VM, so that the application program obtains the transmission speed of the virtual NIC via the internal interface.

Optionally, when determining whether the transmission speed of the virtual NIC needs to be modified, the processor 602 is further enabled by the machine executable instructions to perform the following steps:

determining whether network bandwidth usage of the application program running in the VM reaches a preset threshold; and

if the network bandwidth usage reaches the preset threshold, determining that the transmission speed of the virtual NIC needs to be modified.

Optionally, when determining whether the transmission speed of the virtual NIC needs to be modified, the processor 602 is further enabled by the machine executable instructions to perform the following steps:

determining whether a user has changed network bandwidth; and

if the user has changed the network bandwidth, determining that the transmission speed of the virtual NIC needs to be modified.

This embodiment of the present disclosure further provides a machine readable storage medium, storing machine executable instructions, where the machine executable instructions are executed by a processor to implement the following steps:

after a VM is started, configuring an initial transmission speed of a virtual NIC in the VM by using an internal interface set in the VM, and saving the initial transmission speed in the virtual NIC, where the internal interface is used to configure a transmission speed of the virtual NIC and allow communication with an external interface of a physical machine; and

during the running of the VM, if the transmission speed of the virtual NIC needs to be modified,

invoking the external interface to obtain a target transmission speed, and

reconfiguring the target transmission speed as the transmission speed of the virtual NIC via the internal interface.

Optionally, when generating the internal interface, the processor is enabled by the machine executable instructions to perform the following steps:

obtaining a system file of the virtual NIC;

adding a specified field to the system file; and

using the system file added with the specified field as the internal interface.

Optionally, when saving the initial transmission speed in the virtual NIC, the processor is enabled by the machine executable instructions to perform the following steps:

reading the initial transmission speed from the specified field of the internal interface; and

saving the initial transmission speed in the virtual NIC.

Optionally, when reconfiguring the target transmission speed as the transmission speed of the virtual NIC via the internal interface, the processor is enabled by the machine executable instructions to perform the following steps:

replacing the initial transmission speed in the specified field of the internal interface with the target transmission speed; and

saving the target transmission speed in the virtual NIC.

Optionally, the VM performs communication based on the target transmission speed of the virtual NIC.

Optionally, the target transmission speed includes a real-time speed of an external network or a preset limit speed.

Optionally, the internal interface further allows communication with an application program running in the VM, so that the application program obtains the transmission speed of the virtual NIC via the internal interface.

Optionally, when determining whether the transmission speed of the virtual NIC needs to be modified, the processor is enabled by the machine executable instructions to perform the following steps:

determining whether network bandwidth usage of the application program running in the VM reaches a preset threshold; and

if the network bandwidth usage reaches the preset threshold, determining that the transmission speed of the virtual NIC needs to be modified.

Optionally, when determining whether the transmission speed of the virtual NIC needs to be modified, the processor is enabled by the machine executable instructions to perform the following steps:

determining whether a user has changed network bandwidth; and

if the user has changed the network bandwidth, determining that the transmission speed of the virtual NIC needs to be modified.

The embodiments in this specification are described in a progressive manner. Each embodiment focuses on a difference from other embodiments. Refer to these embodiments for same or similar parts in the embodiments.

A person skilled in the art should understand that the embodiments of the present disclosure may be provided as a method, an apparatus, or a computer program product. Therefore, the present disclosure may use a form of a hardware embodiment, a software embodiment, or an embodiment combining software and hardware. In addition, the present disclosure may use a form of a computer program product implemented on one or more computer available storage media (including but not limited to a disk memory, a Compact Disk Read-Only Memory (CD-ROM), an optical memory) including computer available program code.

The present disclosure is described with reference to flowcharts and/or block diagrams of the method, terminal device (system), and the computer program product in the embodiments of the present disclosure. It should be understood that computer program instructions can implement each process and/or block in the flowcharts and/or block diagrams and a combination of processes and/or blocks in the flowcharts and/or block diagrams. These computer program instructions may be provided to a general-purpose computer, a dedicated computer, an embedded processor, or a processor of another programmable data processing terminal device to generate a machine, so that an apparatus configured to implement functions specified in one or more processes in the flowcharts and/or one or more blocks in the block diagrams is generated by using instructions executed by the computer or the processor of another programmable data processing terminal device.

These computer program instructions may also be stored in a computer readable memory that can guide a computer or another programmable data processing device to work in a specific manner, so that the instructions stored in the computer readable memory generate a product including an instruction apparatus, where the instruction apparatus implements functions specified in one or more processes in the flowcharts and/or one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more processes in the flowcharts and/or one or more blocks in the block diagrams.

Although preferred embodiments of the embodiments of the present disclosure are described once acquiring basic innovative concepts a person skilled in the art may make other changes and modifications to these embodiments. Therefore, the appended claims intend to be explained to include preferred embodiments and all changes and modifications that fall within scope of the embodiments of the present disclosure.

Finally, it should be noted that the relational terms herein such as first and second are used only to differentiate an entity or operation from another entity or operation, and do not require or imply any actual relationship or sequence between these entities or operations. Moreover, the terms “include”, “comprise”, and any variants thereof are intended to cover a non-exclusive inclusion. Therefore, in the context of a process, method, object, or terminal device that includes a series of elements, the process, method, object, or terminal device not only includes such elements, but also includes other elements not specified expressly, or may include inherent elements of the process, method, object, or device. Unless otherwise specified, an element limited by “include a/an . . . ” does not exclude other same elements existing in the process, the method, the article, or the terminal device that includes the element.

The method for configuring a speed of a virtual NIC, the method for obtaining a speed of a virtual NIC, the method for determining a speed of a virtual NIC, the method for setting a speed of a virtual NIC, and the apparatus for configuring a speed of a virtual NIC in the present disclosure are described in detail above. The principle and implementation of the present disclosure are described herein through specific examples. The description about the embodiments of the present disclosure is merely provided for ease of understanding of the method and core ideas of the present disclosure. Persons of ordinary skill in the art can make variations and modifications to the present disclosure in terms of the specific implementations and application scopes according to the ideas of the present disclosure. Therefore, the specification shall not be construed as a limit to the present disclosure.

What is claimed is:

1. A method for configuring a speed of a virtual network interface card (NIC), comprising:
after a virtual machine (VM) is started, configuring an initial transmission speed of a virtual NIC in the VM by using an internal interface set in the VM, and saving the initial transmission speed in the virtual NIC, wherein the internal interface is used to configure a transmission speed of the virtual NIC and allow communication with an external interface of a physical machine; and
during the running of the VM, if the transmission speed of the virtual NIC needs to be modified,
invoking the external interface to obtain a target transmission speed, and
reconfiguring the target transmission speed as the transmission speed of the virtual NIC via the internal interface.

2. The method according to claim 1, wherein the internal interface is generated in the following manner:
obtaining a system file of the virtual NIC;
adding a specified field to the system file; and
using the system file added with the specified field as the internal interface.

3. The method according to claim 2, wherein the saving the initial transmission speed in the virtual NIC comprises:
reading the initial transmission speed from the specified field of the internal interface; and
saving the initial transmission speed in the virtual NIC.

4. The method according to claim 2, wherein the reconfiguring the target transmission speed as the transmission speed of the virtual NIC via the internal interface comprises:
replacing the initial transmission speed in the specified field of the internal interface with the target transmission speed; and
saving the target transmission speed in the virtual NIC.

5. The method according to claim 1, wherein the VM performs communication based on the target transmission speed of the virtual NIC.

6. The method according to claim 1, wherein the target transmission speed comprises a real-time speed of an external network or a preset limit speed.

7. The method according to claim 1, wherein the internal interface further allows communication with an application program running in the VM, so that the application program obtains the transmission speed of the virtual NIC via the internal interface.

8. The method according to claim 1, wherein the determining whether the transmission speed of the virtual NIC needs to be modified comprises:
determining whether network bandwidth usage of the application program running in the VM reaches a preset threshold; and
if the network bandwidth usage reaches the preset threshold, determining that the transmission speed of the virtual NIC needs to be modified.

9. The method according to claim 1, wherein the determining whether the transmission speed of the virtual NIC needs to be modified comprises:
determining whether a user has changed network bandwidth; and
if the user has changed the network bandwidth, determining that the transmission speed of the virtual NIC needs to be modified.

10. A machine device, comprising a storage medium, a processor, and machine executable instructions that are stored on the storage medium and can be run on the processor, wherein the processor executes the machine executable instructions to implement the following operations, comprising:
after a virtual machine (VM) is started, configuring an initial transmission speed of a virtual network interface card (NIC) in the VM by using an internal interface set in the VM, and saving the initial transmission speed in the virtual NIC, wherein the internal interface is used to configure a transmission speed of the virtual NIC and allow communication with an external interface of a physical machine; and
during the running of the VM, if the transmission speed of the virtual NIC needs to be modified,
invoking the external interface to obtain a target transmission speed, and
reconfiguring the target transmission speed as the transmission speed of the virtual NIC via the internal interface.

11. The machine device according to claim 10, wherein the internal interface is generated in the following manner:
obtaining a system file of the virtual NIC;
adding a specified field to the system file; and
using the system file added with the specified field as the internal interface.

12. The machine device according to claim 11, wherein the saving the initial transmission speed in the virtual NIC comprises:
reading the initial transmission speed from the specified field of the internal interface; and
saving the initial transmission speed in the virtual NIC.

13. The machine device according to claim 11, wherein the reconfiguring the target transmission speed as the transmission speed of the virtual NIC via the internal interface comprises:
replacing the initial transmission speed in the specified field of the internal interface with the target transmission speed; and
saving the target transmission speed in the virtual NIC.

14. The machine device according to claim 10, wherein the VM performs communication based on the target transmission speed of the virtual NIC.

15. The machine device according to claim 10, wherein the target transmission speed comprises a real-time speed of an external network or a preset limit speed.

16. The machine device according to claim 10, wherein the internal interface further allows communication with an application program running in the VM, so that the application program obtains the transmission speed of the virtual NIC via the internal interface.

17. The machine device according to claim 10, wherein the determining whether the transmission speed of the virtual NIC needs to be modified comprises:
determining whether network bandwidth usage of the application program running in the VM reaches a preset threshold; and
if the network bandwidth usage reaches the preset threshold, determining that the transmission speed of the virtual NIC needs to be modified.

18. The machine device according to claim 10, wherein the determining whether the transmission speed of the virtual NIC needs to be modified comprises:
determining whether a user has changed network bandwidth; and
if the user has changed the network bandwidth, determining that the transmission speed of the virtual NIC needs to be modified.

19. A non-volatile machine readable storage medium, storing machine executable instructions, wherein the machine executable instructions are executed by a processor to implement the following operations, comprising:
after a virtual machine (VM) is started, configuring an initial transmission speed of a virtual network interface card (NIC) in the VM by using an internal interface set in the VM, and saving the initial transmission speed in the virtual NIC, wherein the internal interface is used to configure a transmission speed of the virtual NIC and allow communication with an external interface of a physical machine; and
during the running of the VM, if the transmission speed of the virtual NIC needs to be modified,
invoking the external interface to obtain a target transmission speed, and
reconfiguring the target transmission speed as the transmission speed of the virtual NIC via the internal interface.

20. The non-volatile machine readable storage medium according to claim 10, wherein the internal interface is generated in the following manner:
obtaining a system file of the virtual NIC;
adding a specified field to the system file; and
using the system file added with the specified field as the internal interface.
